(19) United States
(12) Patent Application Publication
(10) Pub. No.: US 2013/0174794 A1
(43) Pub. Date: Jul. 11, 2013

(54) Remotely adjustable equestrian barrier

(71) Applicant: Angelina Casiello, Medford, MA (US)

(72) Inventor: Angelina Casiello, Medford, MA (US)

(21) Appl. No.: 13/374,714

(22) Filed: Jan. 10, 2012

(51) Int. Cl. A01K 15/02

(52) U.S. Cl. 119/705

(57) ABSTRACT

A remotely controlled adjustable equestrian barrier that uses motorized threaded rods located inside hollow support posts to drive mating threaded nuts up or down simultaneously to raise or lower a rail that is supported by rail cups that are attached to each threaded nut. Each post has a vertical slot that allows the rail cup to be attached to the nut and to freely travel up or down along with the mating nut. When the device is turned on, the support cups automatically lower to their lowest point so that the rail starts in its lowest position parallel to the ground. As each rod turns, a cam that is fixed to each rod causes a micro switch to turn on and off for each revolution. A micro processor keeps track of the number of revolutions and turns the drive motors off when the rail reaches the desired height.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of horse training devices and more specifically to a remotely adjustable equestrian barrier.

Jumping coursed for equestrian jumping typically include a number of static jump barriers. A standard jump barrier consists of a left and right support structure with one or more rails spanning the distance between the two support structures. When training a horse, it is often desirable to raise or lower the height of the rail. To do this, the rider is required to dismount from his or her horse, remove the rail, adjust the height of the rail cups and then replace the rail.

This is a time consuming and disruptive process.

To automate this process, it makes sense to design and build a device that allows the rail to be raised or lowered automatically by remote control. To this end Michael McComb, in his U.S. Pat. No. 6,715,448 discloses a remotely adjustable equestrian barrier. However, the McComb design involves expensive encoder wheels to determine rail height. Furthermore, the McComb design uses a cable system to raise and lower the rail, which is prone to breakage and possible stretching over time. Even though the encoder wheels are counting rotation of the shaft of the drive motors, there is no guarantee that over time, the motor pulling one end of the cable will get out of sync with the motor driving the other end of the cable, causing the rail not to be parallel with the ground plane. Additionally, the transmitting device described by McComb includes many switches that need to be viewed and selected by the user while riding his or her horse. This can be very difficult under normal riding conditions. The selection process also requires a more complicated electronic assembly which adds to the cost of the overall system. Finally, the external nature of the rail raising and lowering mechanism exposes the mechanism to the effects of adverse weather conditions including moisture, mud and dirt which may adversely affect the smooth operation of the device.

### BRIEF SUMMARY OF THE INVENTION

The primary object of the invention is to provide a remotely adjustable equestrian barrier that allows a person to adjust the height of the barrier without dismounting from his or her horse.

Another object of the invention is to provide a remotely adjustable equestrian barrier that is economical to manufacture.

Another object of the invention is to provide a remotely adjustable equestrian barrier that insures that the barrier rail remains parallel to the ground plane.

Another object of the invention is to provide a remotely adjustable equestrian barrier that is weather resistant.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a remotely adjustable equestrian barrier comprising: a pair of spaced apart first and second hollow posts, a pair of standard structures to support said first and second posts, a horizontally disposed rail, a first and second rail cup, a first and second gear motor, a first and second threaded nut, a first and second threaded rod, a first and second cam, a first and second cam counting switch, a first and second lower limit switch, a first and second upper limit switch, a micro processor, a motor controller, a power source, an RF transmitter, and an RF receiver, one said rail end held by said first rail cup and the opposite rail end held by said second rail cup, said first and second gear motor shafts each attached to said first and second threaded rod, said first and second gear motors powered by a battery power supply, said first and second gear motors and said threaded rods each retained within the hollow portion of said first and second posts, said first and second nuts each threaded onto said first and second threaded rods, said first and second rail cups each fixedly attached to said first and second nuts, said first and second hollow posts each having a longitudinal slot allowing each said rail cups to slide up and down on the outside surface of each said post, said first and second cam each fixedly attached to each said threaded rod, said first and second cam counting switch each mounted within each said hollow post, each said cam switch turning on and off with each revolution of said cam as it rotates about said threaded rod, said first and second lower limit switches each mounted toward the bottom of each said hollow post and activated when said switch lever makes contact with the bottom surface of said rail cup, said microprocessor and said motor controller given signals by said RF transmitter and said RF receiver to turn said motor shafts in a clockwise or counter clockwise direction depending on the intent of the user to have said rail cups and said rail travel in an upward direction or a downward direction.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a partial side section view of the invention.

FIG. 3 is a partial perspective view of one support post.

FIG. 4 is a perspective view of the hand held transmitter.

FIG. 5 is a top view of one support post.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

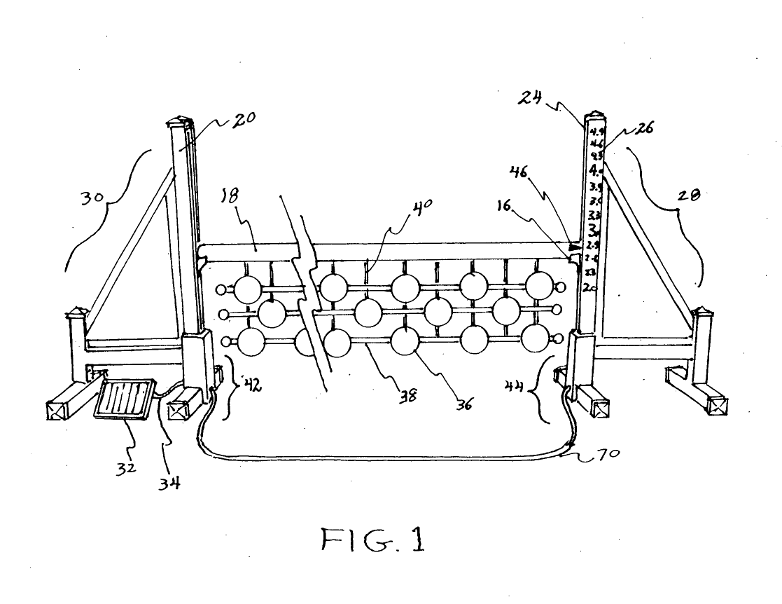

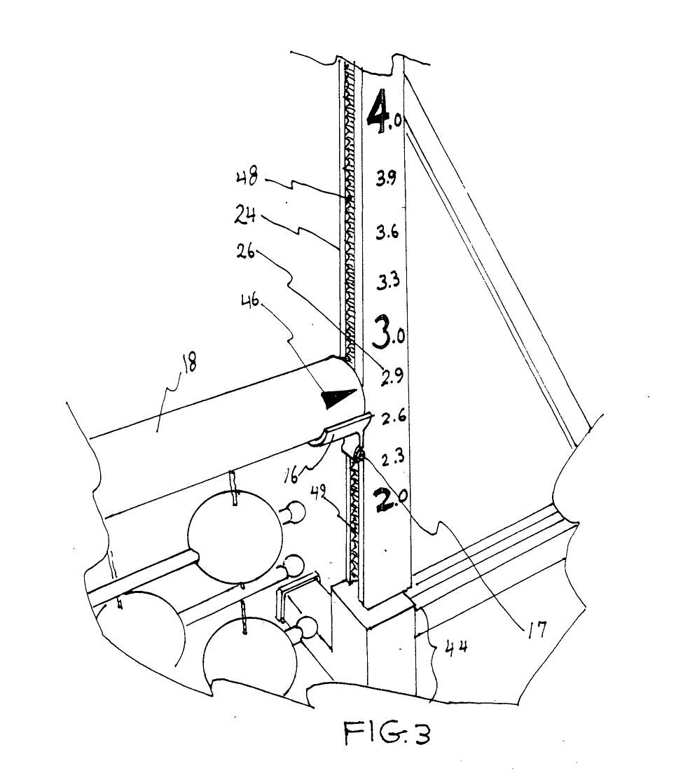

Referring now to FIG. 1 we see a perspective view of the remotely adjustable equestrian barrier of the present invention. Two rail holding cups 14, 16 protrude from two vertical hollow support posts 20, 24 and hold horizontal rail 18. Rail 18 has been shortened for drawing purposes. It is normally ten feet long. Right support post 24 has indices 26 printed on the outside surface that indicate height markings. The lowest marking is two feet and the highest is 5 feet. There are intermediate markings every three inches as shown clearly in FIG. 3. Obviously, the support posts 20, 24 and associated rail raising and lowering mechanism can be higher or lower than five feet. An indicating arrow 46 points to the correct rail height incises 26 and can be read from 100 feet away. Rail 18 can be raised or lowered remotely by the user as will be explained in detail below. A secondary barrier is comprised of vertical support cables 40, hollow spheres 36 and horizontal cross bars 38. The secondary barrier is attached to the main rail 18 and raises or lowers with the main rail 18. The vertical attachment cables 40 of the secondary barrier are flexible so that when the lowest portion of the secondary barrier touches the ground, the cables 40 can fold and collapse as the rail 18 lowers. Vertical posts 20 24 are supported by standard support structures 28, 30. The motorized drive components are housed within lower support housing 42, 44. A photovoltaic cell 34 is connected to battery 50 by cable 34 and supplies electricity to a battery 50 stored within housing 42. An electrical cable 70 connects power and signal controls from one support housing 42 to the other 44. However, this cable can be eliminated if a second receiving circuit and battery were placed inside hollow lower post housing 44. This option however would make the entire assembly more significantly more expensive to manufacture.

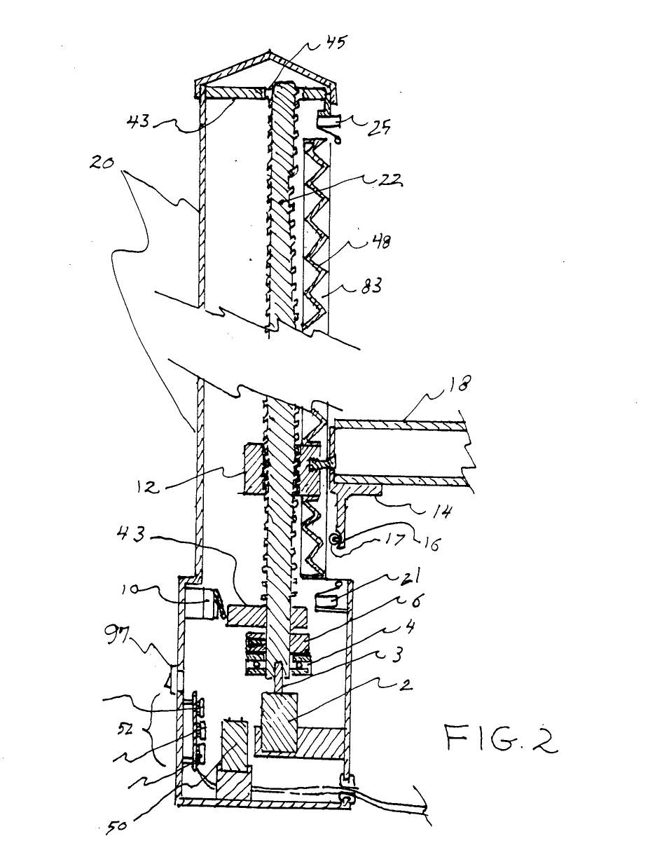

FIG. 2 shows a partial section view that vertically bisects hollow post 20. Support structure 30 is not shown for clarity purposes. A gear motor 3 is supported by a base plate 3 that is fastened to the side wall of lower post housing 42. The twelve volt DC gear motor runs at approximately two hundred RPM and is powered by twelve volt DC battery 50. Electronic control assembly 52 includes a micro processor 53, a motor controller 55 and a receiver 57 and is mounted to the inside wall of housing 42. Motor shaft 4 is fixedly and centrally attached to the lower portion of threaded rod 22. A rod retaining plate 43 includes an aperture 45 that is larger than the diameter of rod 22 and holds it so that it can rotate in place. Thrust bearing 4 sits in fixed bracket 5. Shaft collar 6 is fixed to threaded rod 22 and rests on thrust bearing 4 thereby absorbing the weight of rod 22 so that the weight of rod 22 is not imposed on motor shaft 3 and its associated shaft bearings. Cam member 8 is fixed to rod 22. Micro switch 10 is fixed to the inside wail of housing 42 so that its spring biased lever arm 43 is flexed outward when the thinner portion of cam 8 is in front of it, and flexes inward making a switch contact when the fatter part of cam 8 engages lever arm 43. In this way, every rotation of threaded rod 22 can be counted by a microprocessor located in electronics assembly 52. This is a much less expensive way of counting revolutions when comparing to using an optical encoder and photo diode or other counting electronics assemblies. Nut 12 engages the threads of rod 22. The nut 12 travels up or down rod 22 as rod 22 is turned clockwise or counter clockwise by gear motor 2. Micro switch 19 is mounted on the side wall of housing 42 in such a way that the switch lever 21 is pressed down when the bottom portion 16 of rail cup 14 reaches it thereby turning off motor 2. Roller 17 is attached near the bottom of rail cup member 14 and rides along the outside surface of post 20 creating a friction free movement as cup 14 and associated rail 18 travel up and down. Upper limit switch 25 is fixed to post 220 wall and turns off motor 2 when its lever arm is forced down by the top surface of rail cup 14.

In the preferred embodiment of the present invention, The threaded rod 22 has ten threads per inch and is turned by gear motor 2 at two hundred RPM causing an upward or downward travel speed of a one inch rise or fall every three seconds.

FIG. 3 shows a partial perspective view of support structure 28, hollow post 24 and rail 18. Arrow marking 46 printed on rail 18 can be clearly seen as it points to a height marking indices 26 printed on post 24. Roller 17 can be seen as it rolls up or down on the outside surface of post 24. An accordion type closure 48, 49 is placed in the slot of post 24 where the rail cup assembly 14 joins the nut 12 inside post 24. The accordion closure 48 is made of water resistant material and helps keep out undesirable dust, dirt and moisture from the inside of post 24 and lower motor housing 44. Off-On switch 97 turns on or off the entire electrical assembly of the invention.

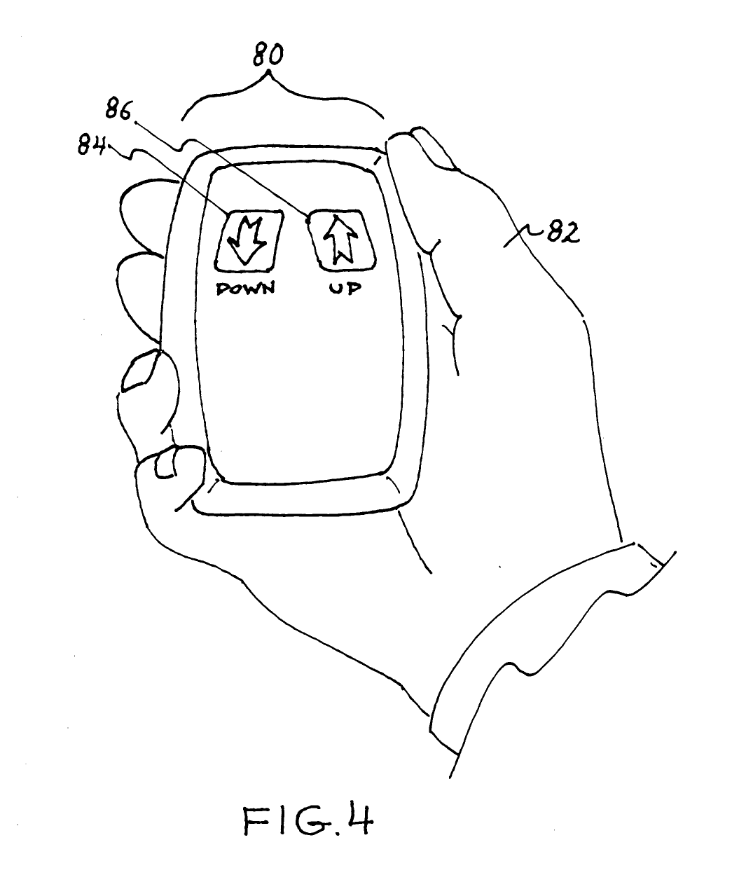

FIG. 4 shows a perspective view of hand held transmitter housing 80. The housing 80 fits easily in a person's hand 82 and can be made even smaller if necessary. The operation of the device 80 is very simple. By momentarily pressing on up button 86 the rail 18 moves up three inches. By pressing and holding up button 86 the rail 18 continues moving upward until the user removes his or her finger from the button 86. The same is true with the down motion when down button 84 is pressed.

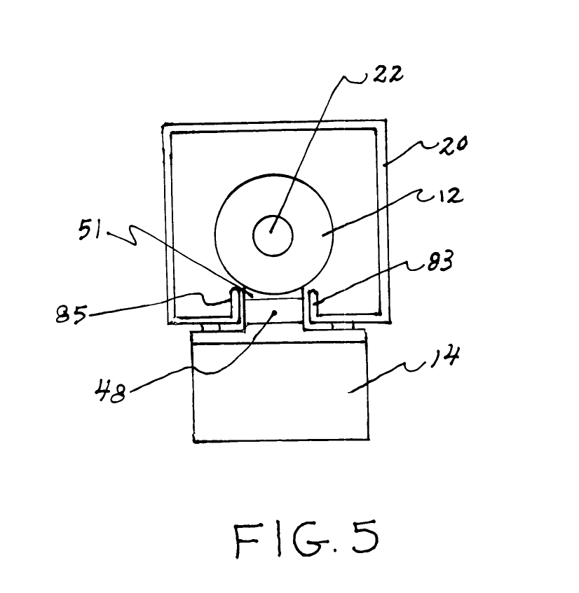

FIG. 5 shows a top view of the hollow post 20. Rod retaining plate 43 is removed for clarity purposes. Rod 22 with threaded nut 12 in place. A T portion 51 coming from rail cup 14 enters post slot walls 83, 85 and is fixedly attached to nut 12. Accordion closure 48 fills the vertical slot area formed by walls 83 and 85.

The microprocessor 53 is programmed so that when the user turns on the main power switch 97 both drive motors turn counter clockwise and cause the rail 18 to lower until the rail cups 14, 16 contact limit switches 21 and a similar switch located in lower post housing 44. After touching the switches 21 the micro processor instructs the motors to turn clockwise for a second until the lever arms of the limit switches 21 are released. This becomes the starting point for future commands to the motors to raise or lower rail 18. This configuration insures that the rail starts in, and is more likely to remain in a parallel position with respect to the ground plane.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. remotely adjustable equestrian barrier comprising:
a pair of spaced apart first and second hollow posts;
a pair of standard structures to support said first and second posts;
a horizontally disposed rail;
a first and second rail cup;
a first and second gear motor;
a first and second threaded nut;
a first and second threaded rod;
a first and second cam;
a first and second cam counting switch;
a first and second lower limit switch;
a first and second upper limit switch;
a micro processor;
a motor controller;
a battery power source;
a connecting cable;
an RF transmitter; and
an RF receiver;
one said rail end held by said first rail cup and the opposite rail end held by said second rail cup;
said first and second gear motor shafts each attached to said first and second threaded rod;
said first and second motors electrically connected by said connecting cable and powered by said battery power source;
said first and second gear motors and said threaded rods each retained within the hollow portion of said first and second posts;
said first and second nuts each threaded onto said first and second threaded rods;
said first and second rail cups each fixedly attached to said first and second nuts;
said first and second hollow posts each having a longitudinal slot allowing each said rail cups to slide up and down on the outside surface of each said post;
said first and second cam each fixedly attached to each said threaded rod;
said first and second cam counting switch each mounted within each said hollow post;
each said cam switch turning on and off with each revolution of said cam as it rotates about said threaded rod;
said first and second lower limit switches each mounted toward the bottom of each said hollow post and activated when said switch arm makes contact with the bottom surface of said rail cup;
said microprocessor and said motor controller given signals by said RF transmitter and said RF receiver to turn said motor shafts in a clockwise or counter clockwise direction depending on the intent of the user to have said rail cups and said rail travel in an upward direction or a downward direction.

2. A remotely adjustable equestrian barrier as claimed in claim 1 further comprising an accordion type closure that is attached to said threaded nut on one end and attached to the upper and lower portion of said post slot thereby filling said slot space and protecting said space from dust, dirt and moisture.

3. A remotely adjustable equestrian barrier as claimed in claim 1 whereupon turning on said invention said microprocessor instructs said motors to turn in a counterclockwise rotation until said lower limit switches are actuated;
said action insuring that said rail starts in a parallel position with respect to the ground plane.

3. A remotely adjustable equestrian barrier as claimed in claim 1 further comprising a pair of upper limit switches each fixedly mounted near the top of each hollow post whose lever arms are activated when said rail cups reach the top of said hollow posts causing said drive motors to be turned off.

4. A remotely adjustable equestrian barrier as claimed in claim 1 wherein an alternate embodiment includes a second set of electronics and a second battery are installed within the base of said second hollow post allowing said second drive motor to be actuated without need of the said cable that connects said first post and said second post.

5. A remotely adjustable equestrian barrier as claimed in claim 1 also comprising a photovoltaic panel that is connected to said battery power supply;
said photovoltaic panel capable of recharging said battery power supply.
